(19) United States
(12) Patent Application Publication
(10) Pub. No.: US 2013/0157800 A1
(43) Pub. Date: Jun. 20, 2013

(54) Limited Slip Planetary Gear Transmission

(71) Applicants: Peter Ward, Farmington Hills, MI (US); Dean Schneider, Washington, MI (US); Alexander Serkh, Troy, MI (US); Imitaz Ali, Lathrup Village, MI (US)

(72) Inventors: Peter Ward, Farmington Hills, MI (US); Dean Schneider, Washington, MI (US); Alexander Serkh, Troy, MI (US); Imitaz Ali, Lathrup Village, MI (US)

(21) Appl. No.: 13/325,302

(22) Filed: Dec. 14, 2011

(51) Int. Cl. F16H 3/44

(52) U.S. Cl. 475/311; 475/323

(57) ABSTRACT

A limited slip planetary gear transmission comprising an input member, an output member, a planetary gear set coupled between the input member and the output member, the planetary gear set having a sun gear, and a brake member directly coupled to the sun gear, the brake member controls an output torque of the planetary gear set by controlling a speed of the sun gear.

### FIELD OF THE INVENTION

The invention relates to a limited slip planetary gear transmission, and in particular, to a limited slip planetary gear transmission having a brake member engaging a rotating portion of a planetary gear set for controlling an output torque of the planetary gear transmission.

### BACKGROUND OF THE INVENTION

The invention relates to planetary gear sets. Planetary gear sets are typically unitary assemblies comprising a sun gear, carrier, pinions, and a ring gear. The planetary gear set subassembly is then incorporated into a larger mechanical device, such as an automotive transmission. The output power or torque of the larger device into which a planetary gear set is incorporated is routinely controllable. For certain applications it would be desirable to control the torque output of the planetary gear set proper by directly controlling the torque of one or more of the planetary gear set components such as the sun gear or carrier.

Representative of the art is U.S. Pat. No. 5,106,351 which discloses a transfer case for a four wheel drive vehicle providing a central shaft defining a first output concentrically surrounded by a forward high/low drive range gear set and an aft dual planetary inter-axle differential gear set. A range clutch collar is disposed between the gear sets for selectively providing four wheel drive low range, neutral, and full-time four wheel drive high range. Likewise, a mode sleeve is disposed between the gear sets for selectively locking the differential gear set when the vehicle is shifted into its four wheel low range. Inner and outer relatively rotational drum housings surround the aft dual planetary differential gear set for defining an annular viscous fluid coupling chamber therebetween. The inner drum is formed with internal annulus gear teeth meshed with a portion of the dual planetary gear set for rotation with the first output shaft while the outer drum is interconnected to a second output for providing full-time four wheel drive differentiation with limited slip between the first and second outputs.

What is needed is a limited slip planetary gear transmission having a brake member engaging a rotating portion of a planetary gear set for controlling an output torque of the planetary gear transmission. The present invention meets this need.

### SUMMARY OF THE INVENTION

The primary aspect of the invention is to provide a limited slip planetary gear transmission having a brake member engaging a rotating portion of a planetary gear set for controlling an output torque of the planetary gear transmission.

Other aspects of the invention will be pointed out or made obvious by the following description of the invention and the accompanying drawings.

The invention comprises a limited slip planetary gear transmission comprising an input member, an output member, a planetary gear set coupled between the input member and the output member, the planetary gear set having a sun gear, and a brake member directly coupled to the sun gear, the brake member controls an output torque of the planetary gear set by controlling a speed of the sun gear.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a cross-sectional view of the preferred embodiment.

FIG. 2 is an exploded view of the embodiment in FIG. 1.

FIG. 3 is a cross-sectional view of an alternate embodiment.

FIG. 4 is an exploded view of the embodiment in FIG. 3.

### DETAILED DESCRIPTION OF THE PREFERRED EMBODIMENT

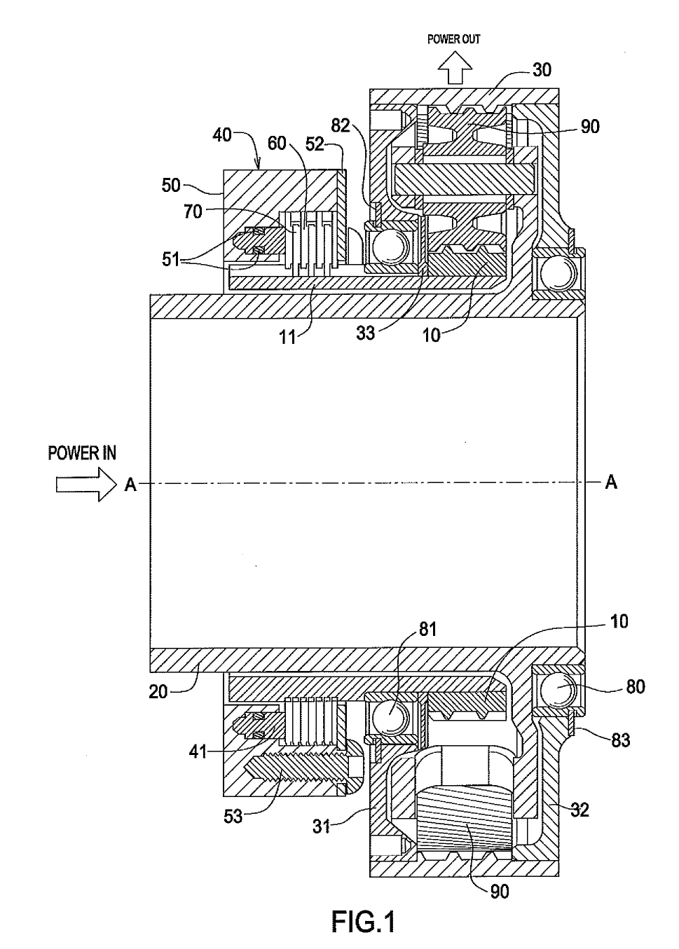

FIG. 1 is a cross sectional view of the inventive transmission. Carrier 20 rotates about an axis A-A. Carrier 20 may be press fit on a rotating shaft (not shown).

A plurality of pinion gears 90 are journalled to carrier 20. Each pinion gear 90 meshes with ring gear 30 and sun gear 10. Sun gear member 11 further comprises a shaft which is coaxial with carrier 20 about axis A-A. In this embodiment sun gear 10 is frictionally engaged with brake 40 through sun gear member 11.

Ring gear 30 rotates upon sun gear member 11 through bearing 81. Ring gear 30 rotates upon carrier 20 through bearing 80. In this embodiment the power output is through ring gear 30 and the power input is through carrier 20.

Brake 40 comprises a housing 50, and interleaved plates 60 and 70. Plates 60 comprise a frictional material known in the clutch and brake arts. Plates 70 comprise a frictional material known in the clutch and brake arts. Plates 60 are mounted to housing 50. Plates 70 are mounted to sun gear member 11. Piston 41 urges plates 60 into frictional engagement with plates 70. Frictional engagement between plates 60 and plates 70 applies a drag torque to sun gear member 11, thereby slowing rotation of sun gear 10, which in turn reduces the output torque of the device. Brake 40 may also comprise other types of brakes as known in the art, such as a cone or band brake. In an alternate embodiment piston 41 may further comprise a pneumatic or hydraulic cylinder connected to a control system (not shown).

In FIG. 1 the device is configured as a planetary gear set where sun 10 is the reaction gear and the carrier 20 is the input to create an output speed increase at ring 30. In an alternative embodiment ring 30 could be the input resulting in a speed reduction at output carrier 20. Sun 10 would be held fixed to create the speed ratio, but could also be slipped to vary the output speed, each selected speed using brake 40.

To illustrate operation, assume that the transmission is used as a speed increaser wherein ring 30 is the output and carrier 20 is the input. The ratio of the transmission when sun 10 is held to no rotation by brake 40 is:

$$\frac{1}{( 1 + \frac{S}{R} )}$$

### Where,

S is number of teeth on sun 10
R is the number of teeth on ring 30

In this example sun 10 has 12 teeth and ring 30 has 60 teeth so that the ratio is 0.83:1. If carrier 20 is spinning at 1,000 RPM with 12 Nm torque and sun 10 is not rotating due to application of brake 40 then ring 30 spins at 1,200 RPM and at a torque of 10 Nm. It is possible to slip brake 40 to have any speed less than 1,200 RPM at ring 30. If the desired speed of ring 30 is 1100 RPM the applied force to brake 40 can be reduced to allow sun 10 to slip.

To calculate the slip speed required at sun 10 the following calculation is used:

(R+S)ωCARRIER=RωRING+SωSUN

ωCARRIER is the speed of the carrier
ωRING is the speed of the ring
ωSUN is the speed of the sun

In this case the slip speed of sun 10 is 500 RPM to slow ring 30 to 1100 RPM from 1200 RPM. The power loss is simply the product of the change in speed at ring 30 and the torque at ring 30 as shown in the equation:

$$Ploss = \frac{2 π}{60 s \text{/} min} ( Δω RING ) ( TRing )$$

The power lost from slipping ring 30 is approximately 105 Watts. The torque at sun 10 is lower at 2 Nm because the speed at sun 10 is higher at 500 RPM. The power loss is easier to manage at a higher speed because the required force applied to plate 60 and plate 70 is lower. The lower applied force allows reduction of the overall physical size of plate 60, plate 70, and housing 50.

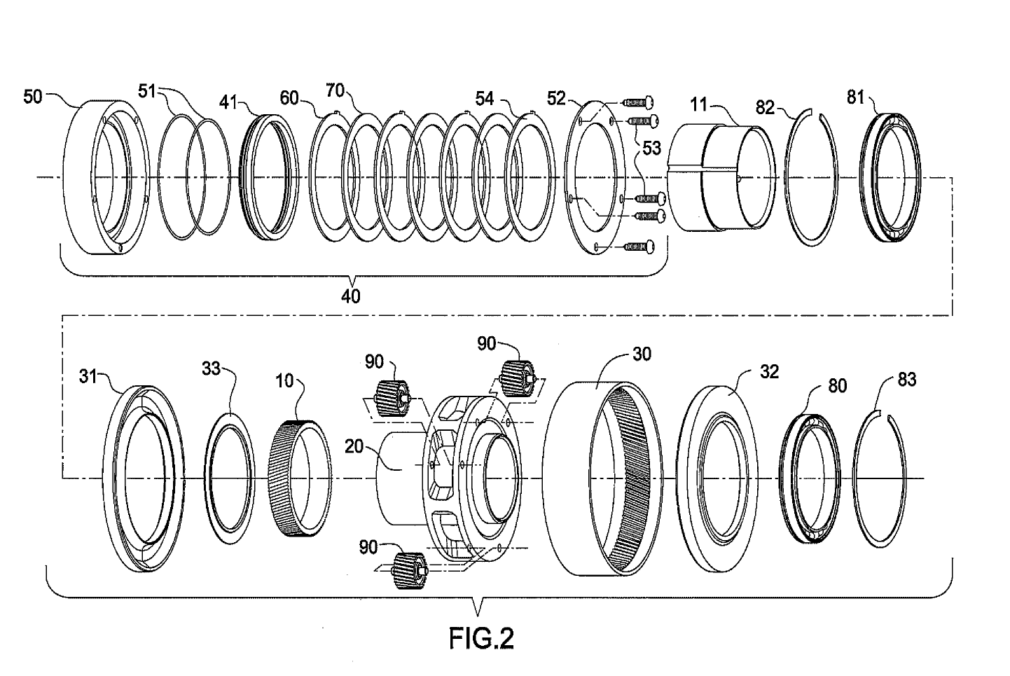

FIG. 2 is an exploded view of the embodiment in FIG. 1. O-rings 51 prevent debris from entering the housing and reaching the plates 60, 70. O-rings 51 are also used to seal piston 41 as a pressure boundary. Housing cover 52 is fixed to the housing 50 using bolts 53. A plate 60 bears upon an end plate 54.

Snap ring 82 retains bearing 81 in ring carrier 31. Deflector 33 directs oil into the gear mesh interface between pinion 90 and sun 10. Ring gear 30 is retained between ring carrier 31 and ring carrier 32. Snap ring 83 retains bearing 80 in ring carrier 32.

In this embodiment, three pinion gears 90 are journalled to carrier 20, although more pinions may be used depending upon the needs of a user. Sun gear 10 is press fit on an outer surface of sun gear member 11.

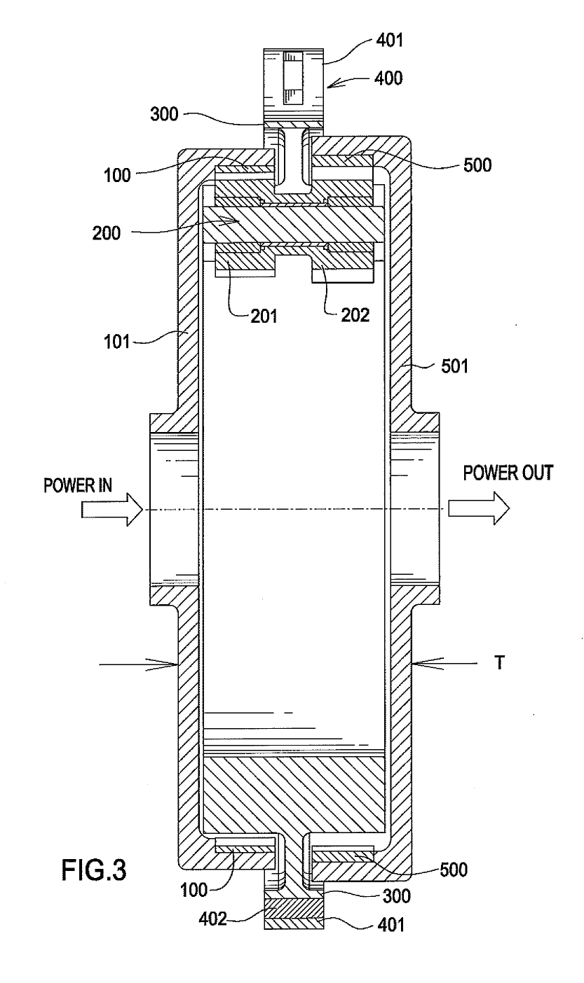

FIG. 3 is a cross-sectional view of an alternate configuration. In this embodiment, the brake mechanism is applied to the carrier 300, wherein the embodiment in FIG. 1 the brake mechanism is applied to the sun gear 10.

In this embodiment two ring gears (100, 500) share a common carrier 300 with a compound pinion 200, where the carrier is the reaction element. Ring 100 is the input to create a speed increase at output ring 500. Carrier 300 is the reaction member that is prevented from rotating or is slipped using brake 400. As noted for the embodiment in FIG. 1, the power flow may be in either direction, namely, with input through ring carrier 501 and output through ring carrier 101 for a speed decrease transmission.

Ring gear 100 is disposed on an inner surface of ring carrier 101. Ring gear 100 meshes with a plurality of compound pinions 200. Compound pinions 200 are journalled around carrier 300. Each compound pinion 200 comprises two gears, namely, gear 201 and gear 202. Each gear 201 and gear 202 has a different number of teeth. Ring gear 100 meshes with each gear 201.

Ring gear 500 is disposed on an inner surface of a ring carrier 501. Ring gear 500 meshes with each gear 202 on each compound pinion 200.

Band brake 400 frictionally engages an outer circumferential surface 301 of carrier 300. Band brake comprises a band 401 upon which is mounted frictional material 402. Frictional material 402 frictionally engages surface 301. Band brake 400 operates in a manner known in the art using a mechanical means to constrict the band upon surface 301, thereby increasing the frictional force applied to the carrier. Such means can include but are not limited to an electric actuator, a pneumatic or hydraulic piston, an Acme-type screw or simple lever (none shown).

In operation, each gear comprises a predetermined number of teeth. Each gear may have any number of teeth as known in the art as required by a user. In the instant embodiment ring 100 has 107 teeth. Compound pinion 200 has two gear teeth profiles. Gear 201 has 13 teeth that mesh with ring 100 and gear 202 has 17 teeth that mesh with ring 500. Ring 500 has 111 teeth.

If ring 100 is rotated at 1,000 RPM and carrier 300 is held fixed (no rotation) by brake 400 then ring 500 will spin at 1,260 RPM. The speed of ring 500 can be decreased by allowing carrier 300 to slip by partially releasing brake 400. For example, to achieve 10% slip at ring 500, carrier 300 must be slipped so that carrier 300 spins at 485 RPM. The change in speed at ring 500 and ring carrier 501 is 126 RPM, but the increase in speed of carrier 300 allowed by the 10% slip means a lower torque must be managed by brake 400 making it possible to have a smaller applied force to the braking mechanism.

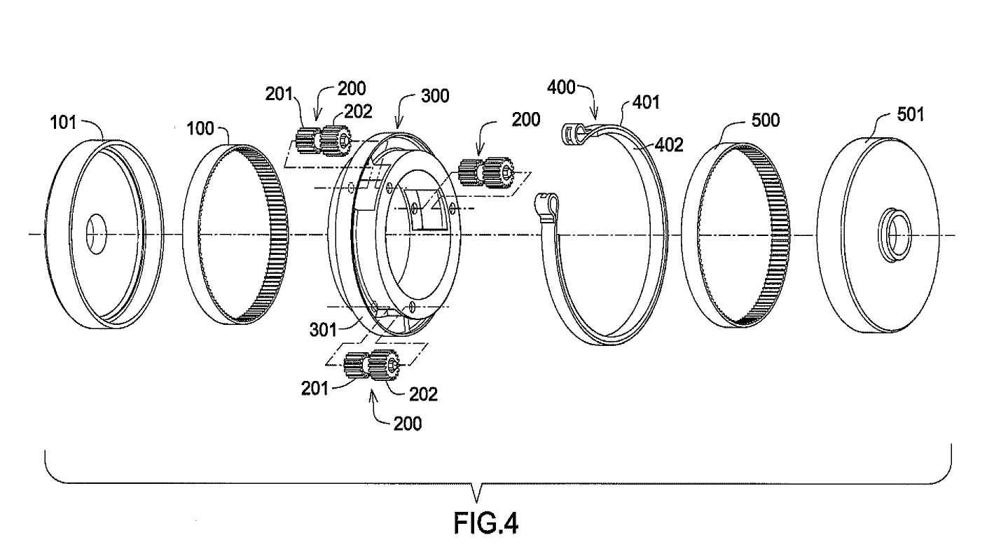

FIG. 4 is an exploded view of the embodiment in FIG. 3. In this embodiment, three compound pinions 200 are journalled to carrier 300. Band brake 400 is disposed radially outwardly of carrier 300. This arrangement allows the transmission to have a thin profile thickness T, allowing use in confined areas.

The inventive device makes speed control simple and precise. The control system can monitor the speed and/or torque at the output and at the reaction member enabling the slipping element to constantly be varied to enable a constant speed at the output.

There are several methods that can be used to measure the torque of the slipping or braked element. Some examples of torque measurement are load cells and the use of an elastic element such as torsion or compression springs. The elastic element has a known spring rate which can be used with a measured angular or linear displacement to measure torque.

Although forms of the invention has been described herein, it will be obvious to those skilled in the art that variations may be made in the construction and relation of parts without departing from the spirit and scope of the invention described herein.

We claim:

1. A limited slip planetary gear transmission comprising:
an input member;
an output member;
a planetary gear set coupled between the input member and the output member, the planetary gear set having a sun gear; and
a brake member directly coupled to the sun gear, the brake member controls an output torque of the planetary gear set by controlling a speed of the sun gear.

2. The limited slip planetary gear transmission as in claim 1, wherein the output member comprises a ring gear.

3. The limited slip planetary gear transmission as in claim 1, wherein the input member comprises a planetary gear carrier.

4. The limited slip planetary gear transmission as in claim 1, wherein the brake member comprises a plurality of plates.

5. The limited slip planetary gear transmission as in claim 1, wherein the output member comprises a planetary gear carrier.

6. The limited slip planetary gear transmission as in claim 1, wherein the input member comprises a ring gear.

7. A limited slip planetary gear transmission comprising:
an input member;
an output member coaxial with the input member;
a planetary gear set coupled between the input member and the output member; and
a brake member coupled to the planetary gear set for controlling an output member torque.

8. The limited slip planetary gear transmission as in claim 7, wherein:
the brake member is coupled to a sun gear;
the brake member comprises a plurality of interleaved plates alternatively connected to a housing and the sun gear; and
an urging member which exerts a predetermined force on the interleaved plates.

9. The limited slip planetary gear set transmission as in claim 7 comprising:
a carrier;
a first ring gear and a second ring gear;
a compound pinion journalled to the carrier and in meshing engagement with the first ring gear and the second ring gear;
the brake member is coupled to the carrier;
the compound pinion having a first gear and a second gear, wherein the number of teeth on the first gear are not equal to the number of teeth on the second gear.

10. The limited slip planetary gear set transmission as in claim 9, wherein the brake member comprises a band brake.

11. The limited slip planetary gear set transmission as in claim 10, wherein the band brake engages a carrier surface.

12. The limited slip planetary gear set transmission as in claim 11, wherein the band brake is disposed radially outwardly of the carrier surface.

13. A limited slip planetary gear transmission comprising:
an input member;
an output member that is coaxial with the input member;
a planetary gear set coupled between the input member and the output member, the planetary gear set having a carrier;
a brake member coupled to the carrier; and
an urging member exerting a force whereby the brake member controls a torque output of the planetary gear set.

14. The limited slip planetary gear set transmission as in claim 13 comprising:
a first ring gear and a second ring gear;
a compound pinion journalled to the carrier and in meshing engagement with the first ring gear and the second ring gear;
the compound pinion having a first gear and a second gear, wherein the number of teeth on the first gear are not equal to the number of teeth on the second gear.

15. The limited slip planetary gear set transmission as in claim 14, wherein the brake member comprises a band brake.

16. The limited slip planetary gear set transmission as in claim 15, wherein the band brake engages a carrier surface.

17. The limited slip planetary gear set transmission as in claim 16, wherein the band brake is disposed radially outwardly of the carrier surface.
